(19) United States
(12) Patent Application Publication
(10) Pub. No.: US 2022/0398823 A1
(43) Pub. Date: Dec. 15, 2022

(54) Video Advertising Signage Replacement

(71) Applicant: MIRAGE DYNAMICS LTD, Beer Sheva (IL)

(72) Inventors: Jihad EL-SANA, Laqiya (IL); Ahmad DROBY, Al-Qadisiyyah (IL)

(21) Appl. No.: 17/775,573

(22) PCT Filed: Nov. 10, 2020
(86) PCT No.: PCT/IL2020/051165

§ 371 Date: May 9, 2022

Related U.S. Application Data
(60) Provisional application No. 62/933,463, filed on Nov. 10, 2019.

(51) Int. Cl. G06V 10/25; G06V 10/74; G06T 3/40; G06T 7/13

(52) U.S. Cl. CPC G06V 10/25; G06V 10/761; G06T 3/40; G06T 7/13; G06T 2207/10016; G06T 2207/20081

(57) ABSTRACT

A system and methods are provided for determining an embedding region in a video stream, including: generating a mask of an initial estimate of an embedding region in a video frame of the video stream, wherein an initial boundary is a boundary of the initial estimate of the embedding region; determining a refined boundary as a region demarked by four best line segments; transforming a replacement image to fit the dimensions of the refined boundary; and inserting the transformed replacement image into the video frame, within the refined boundary.

### FIELD OF THE INVENTION

The present invention relates to the field of image processing, and in particular automated video editing for advertising.

### BACKGROUND OF THE INVENTION

The advertising industry is a multi-billion dollar global industry, and video advertising occupies a considerable portion of the market. Video advertisers try to optimize their delivery of video content for specific target audiences, which is often denoted “local advertising” or “personalized advertising”. Data about clients may be collected in order to propose personalized advertisements, especially over the internet.

Advertisements may be embedded in visual media in static and dynamic forms. Static forms include images that may be subsequently presented in on computer-based media, as well as in physical forms, such as printed on consumer goods. Dynamic advertisements may occupy independent video segments, such as advertising segments on traditional TV broadcasts (which are typically interspersed with traditional content), or internet video streams, dedicated web banners, etc. Each of these forms has advantages and disadvantages for advertisers, including obstacles to localizing and personalizing.

Automated video processing techniques are known for localizing advertising signage appearing in video streams, replacing original advertising content with advertising content (which includes not only commercial advertisements but also various kinds of signage) targeted for a given audience. However, there are still obstacles to making such replacements appear realistic.

Automatic advertisement insertion in sports videos is a well-established domain. For example, Wan et al. (“Robust goal-mouth detection for virtual content insertion,” Proceedings of the Eleventh ACM International Conference on Multimedia, Berkeley, Calif., USA, Nov. 2-8, 2003) selected specific regions in the football field for virtual ads insertion. Chang et al. (Chang, Chia-Hu, et al, “Virtual spotlighted advertising for tennis videos,” Journal of visual communication and image representation 21.7 (2010): 595-612) used tennis-court model fitting and tracking to insert ads, while applying visual acuity analysis and color harmonization to insert the virtual ads to reduce visual disturbance to the viewer.

Prior art methods have not provided a satisfactory solution for automatically analyzing video streams, detecting regions of originally implanted advertisement, and accurately implanting a replacement advertisement.

It is therefore an object of the present invention to provide a system for automatically analyzing video frames and detecting regions of originally implanted advertisement.

It is another object of the present invention to provide a system for automatically detecting regions of originally implanted advertisement without requiring any marking or synchronization to known signs.

It is a further object of the present invention to provide a system for automatically detecting regions of originally implanted advertisement and accurately implanting a replacement advertisement, which is adapted to the properties of the background of the originally implanted advertisement, such as illumination and color harmony.

Other objects and advantages of the invention will become apparent as the description proceeds.

### SUMMARY OF THE INVENTION

An aim of the present invention is to provide a system and method for automated detection of an advertisement embedding region for advertisement or other signage replacement in images and video streams. Embodiments of the present invention provide a system and methods for determining such an embedding region, including steps of: generating a mask of an initial estimate of an embedding region in a video frame of the video stream; identifying multiple line segments in the video frame; calculating line segment scores according to distances between pixels of each line segment and an initial embedding boundary and according to intensity and gradient values at the pixels of each line segments, wherein the initial embedding boundary is a boundary of the initial estimate of the embedding region; determining four best line segments as line segments with best line segment scores with respect to four sides of the initial boundary; determining a refined boundary as a region demarked by the four best line segments; transforming a replacement image to fit the dimensions of the refined boundary; and inserting the transformed replacement image into the video frame, within the refined boundary.

Further embodiments may include calculating the line segment scores as average distances of multiple pixels of the line segments from the initial boundary of the embedding region. Embodiments may also include refining the position and orientation of the best line segments by calculating normal distances between pixels of the best line segments and pixels of the initial boundary. Determining the line segment scores may include calculating for each line segment the value of Σ_{∀p∈l}∇I(p)l(p)f(p)/(d(p)+1), where d(p) is an average distance from the initial boundary, ∇I(p) is a gradient of the line segment at a pixel p, and f(p) is an importance function.

Further embodiments may include calculating the line segment scores by generating a distance map of distances between each pixel of the video frame and the initial boundary, and mapping each line segment to the distance map. Embodiments may also include calculating the line segment scores by computing a distance map of pixel distances in the video frame from an initial boundary of the embedding region.

In some embodiments, determining the refined boundary may also include applying a machine learning algorithm trained to identify the best line segments in an image with respect to an initial boundary.

The method may further comprise the steps of comprising:
before inserting the transformed replacement image into the video frame, analyzing the properties of the background image of the video frame, in the vicinity of the replacement image;
making adaptations in the transformed replacement image to comply with the background properties.

The properties of the background may include one or more of the following:

frequency components;
focus/sharpness;
blur/noise level;
geometric transformations;
illumination.

### BRIEF DESCRIPTION OF THE DRAWINGS

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice.

FIG. 1 is a flow diagram, depicting a process of determining an embedding region in an image, for substitution by a replacement image, in accordance with an embodiment of the present invention;

FIGS. 2-11 are images elucidating the steps of a process of determining an embedding region in an image, for substitution by a replacement image, in accordance with an embodiment of the present invention;

FIGS. 12A and 12B are flow diagrams, depicting alternative processes of determining an embedding region in an image for substitution by a replacement image, based on Machine Learning (ML), in accordance with an embodiment of the present invention; and

FIG. 13 illustrates an improved machine learning model (Points To Polygons Net—PTPNet) for improving the prediction accuracy.

### DETAILED DESCRIPTION OF THE INVENTION

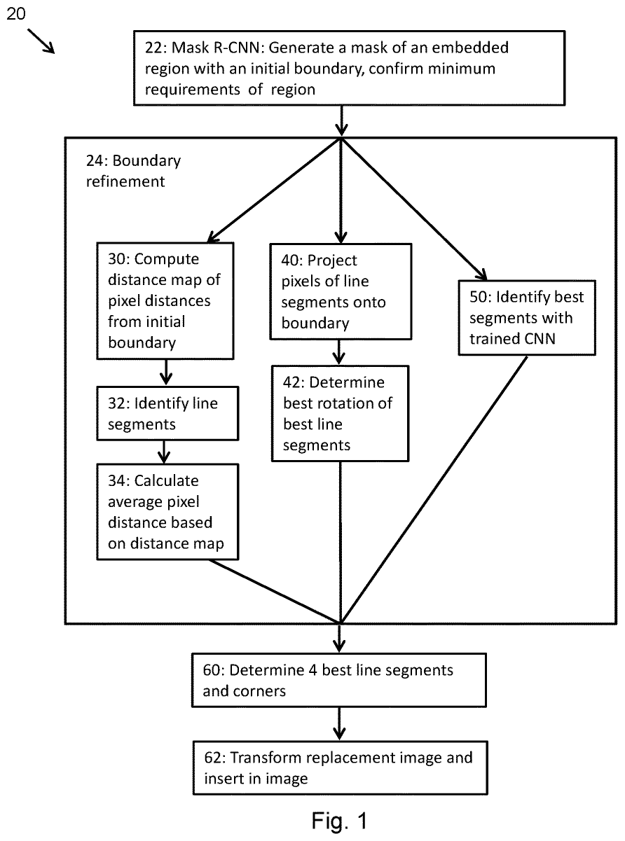

A workflow of the methodology applied here is presented in FIG. 1, which shows a process 20 for determining and applying an embedding region in an image for replacement by a replacement image, according to an embodiment of the present invention.

Embedding a replacement image into a video requires detecting an embedding region in an image space of a video frame and tracking that region in multiple video frames of the video. Hereinbelow, a detailed method and system is described for detecting and refining an embedding region to designate a region of pixels of the image that may then be replaced with a new, personalized advertisement.

A machine learning algorithm may be applied to detect an initial, candidate embedding region in one or more video frames. The advantage of using a machine learning algorithm is that they can autonomously define and detect advertisement-related features. Training the machine learning algorithm may include collecting and labeling a large repository of advertisement images (e.g., signage) from various topics with different contexts. The advertisement in each image of a training set of images may be marked by an enclosing polygon and labeled accordingly.

In some embodiments, a convolutional neural network (CNN) model followed by a recurrent neural network may be trained to detect advertisements that will serve as embedding regions. For example, a Mask R-CNN architecture may be modified using the annotated advertisement database generated with the labeling process described above. Training the model on the generated database enables it to detect and to segment an advertisement in an image. Such training generates a machine learning model that is able to create a mask associated with pixels of an advertisement.

Because of the time required to train a large number of video frames manually, a shortcut may be used by detecting advertisements in initial video frames and tracking them in the following video frames, and labeling additional video frames. Tracking over additional video frames also provides verification of the accuracy of the labeling of the advertisements in each video frame. Temporal coherence among consecutive video frames is utilized and the steps specified below are applied to obtain pixel level accuracy of an embedding region. At the end of the training, a large database of video segments is available, which includes accurately labeled advertisements (which serves as a dataset for training a (Machine Learning) ML model.

At step 22, a generated, labeled database trains a CNN based machine learning model to detect an initial estimate embedding region (e.g., advertisement or signage) in an image or video shot and to generate a mask of the initial embedding region. Processing by the Machine learning model may be performed on a video stream that is live, or “off-line” on a stored video. For real-time (live) video segments, a look-ahead buffer including multiple video frames are used (as there usually is a buffered delay at the receiving end). Before applying the initial embedding region detection, a video segment is subdivided into video shots, where a video shot is defined as a sequence of video frames between two video cuts. A video cut is an abrupt video transition, which separates consecutive video shots. Each video shot is typically processed independently.

Initial embedding regions within a video shot are detected and then ranked according to several parameters, such as the size of the detected regions, the visibility duration, and the shape changes of the embedding region over the video frames of the shot. Typically, a higher priority is given to larger regions, regions which are visible over many video frames, and regions whose shape does not change significantly across the video frames of the shot; i.e., its orientation with respect to the camera does not change significantly. Embedding regions with high scores are then selected for advertisement embedding and tracking in the subsequent steps of process 20 described below.

Each initial, estimated embedding region, is bounded by an “estimated” initial boundary. The determination of pixels that define the boundary is the result of a probabilistic approach used by CNNs in general. To get a higher, pixel-level accuracy, the estimated embedding boundary may then be refined by the methods described hereinbelow with respect to a boundary refinement step 24. Detecting the initial boundary and boundary refinement may be carried out by using a deep learning model or a CNN-based deep learning model.

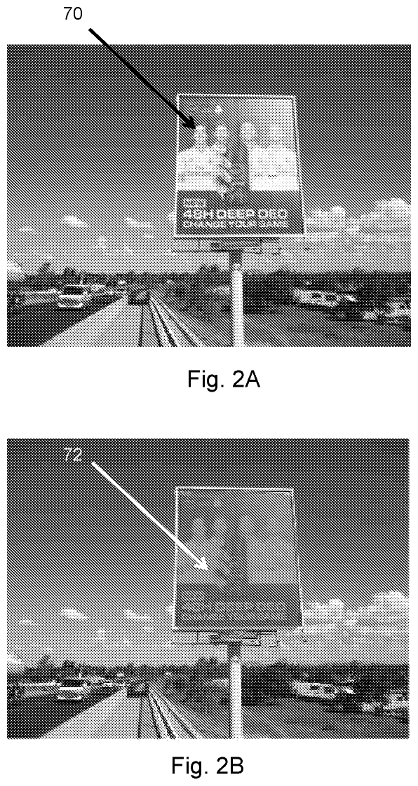

FIG. 2A shows a typical image including an advertisement 40, which may be a video frame of a video shot. Step 22 generates an embedding region mask, by feeding the image or video shot to a trained CNN. The output of this step is shown in FIG. 2B, and is indicated in FIG. 2B as a mask 72 of the pixels of advertisement 70 that are identified as an embedding region.

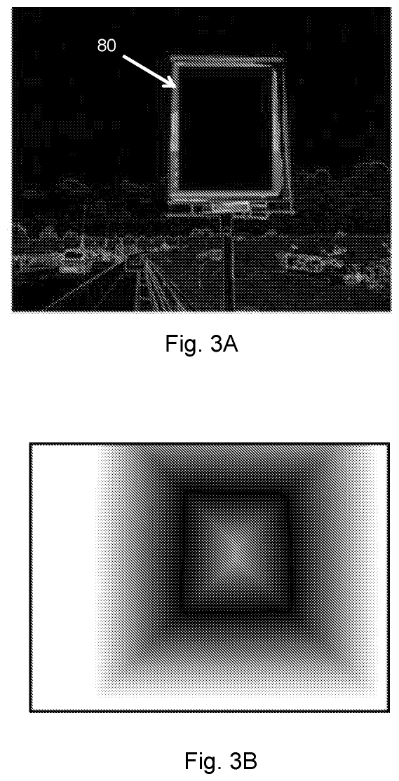

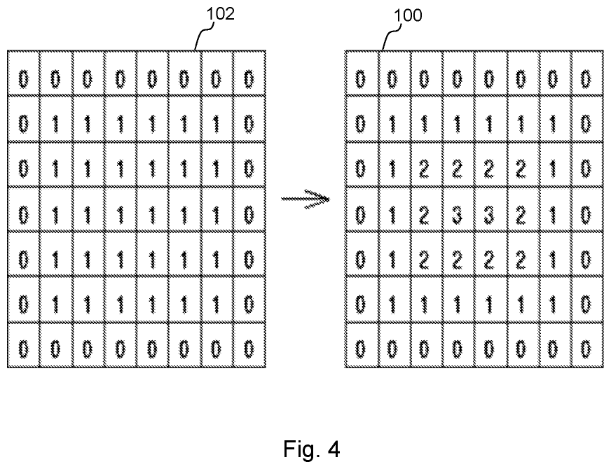

Returning to the process 20 of FIG. 1, at a step 24, the boundaries of the embedded region are refined by one of three methods. A first method begins with step 30, at which a distance map of the image is generated. The value at a pixel of the distance map indicates a distance of the pixel from the edges of the initial embedding region mask. FIG. 3A shows the edges 80 of the initial embedding region mask highlighted. FIG. 3B shows a graphical representation of the distance map, lower values of the distance map indicated by darker shades, higher values by lighter shades. A tabular representation of the distance map is shown in FIG. 4, Table 100, which is generated by indicating, for each pixel of the image, the distance of the pixel from the edge of the embedding region mask, indicated as table 102. (The mask is defined by defining each pixel in the mask as a “1” and each pixel of the image, not in the mask, as a “0”.)

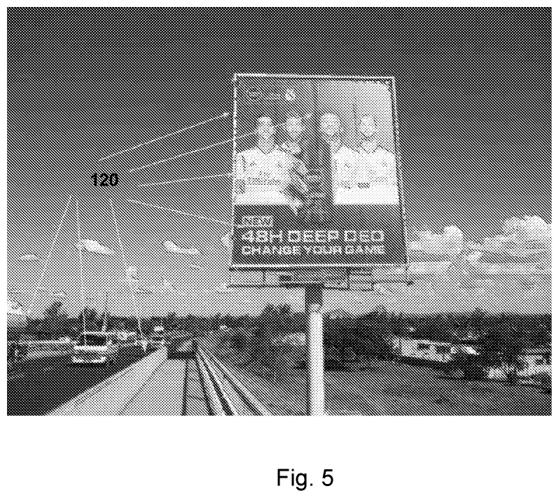

Returning to the process 20 of FIG. 1, at a step 32 line segments of the image are identified, as indicated in FIG. 5 as line segments 120. The line segments may be identified, for example, by using a line segment detector (LSD) algorithm or the Canny edge detector to extract line segments from the original image.

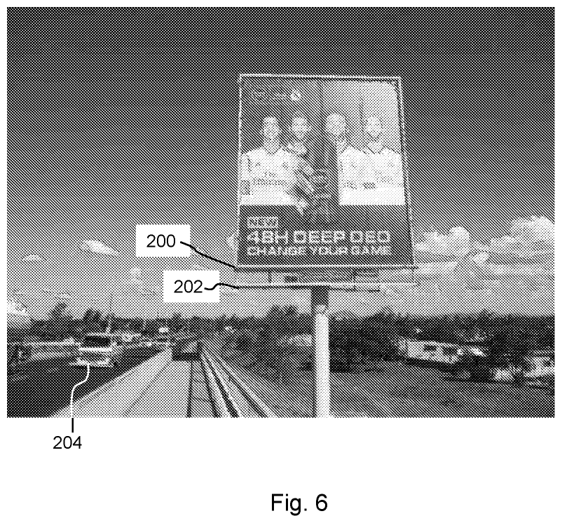

FIG. 6 indicates three exemplary line segments, LS 200 (red), LS 202 (yellow), and LS 204 (green).

Every line segment is mapped onto the distance map, such that the distance map values for each pixel of the line segment can be calculated. At step 34, scores for each segment may be calculated. The calculation may be performed by the following equation:

Σ_{∀p∈l}∇I(p)l(p)f(p)/(d(p)+1) (1)

where d(p) is the average distance from pixels of the segment to the detected boundary, ∇I(p) is the gradient at pixel p, l(p) is the pixel of the segment, and f(p) is an importance function.

For the three line segments, LS 200, LS 202, and LS 204, the following analyses are performed by the system by applying the above equation (1):
The line segment LS 200 is a relatively long segment and on a strong edge, thus, it has large gradient values, which mean that the sum, Σ_{∀p∈l}∇I(p)l(p)f(p), has a relatively high value. In other words, LS 200 is close to the detected boundary (d(p) is small), therefore the sum Σ_{∀p∈l}∇I(p)l(p)f(p)/(d(p)+1) has a relatively high value, which means that L1 is a strong contender for one of the edges of the object.
The line segment LS 204 is a short line segment and is far away from the boundary, which results in a low value of the sum, Σ_{∀p∈l}∇I(p)l(p)f(p), and a high value of d (p). Consequently, there is a low value for the total equation, Σ_{∀p∈l}∇I(p)l(p)f(p)/d(p)+1). This means that LS 204 may not be considered as one of the advertisement edges.
The line segment LS 202 is similar to LS 200 with respect to its length and the strength of the edge it lies on; therefore, the two lines will have a similar value for the sum, Σ_{∀p∈l}∇I(p)l(p). However, LS 202 is farther away from the detected boundary, thus, its average distance, d(p), yields a larger value compared to LS 200. As a result, LS 200 may be preferred to LS 202 as the bottom edge of the embedding region, as described below.

An alternative method of boundary refinement may proceed by projecting pixels of line segments onto the initial boundary, as indicated by a step 40. The line segment scores may be calculated based on some or all pixels on the line segments. Scores may also be calculated as follows: For every pixel on the initial boundary (which is based, for example, on the Mask R-CNN's prediction or on other machine learning methods), and for every line segment within a threshold distance, assign the line segment a score based on the line segment's length, a normal (line orientation), and on the boundary's normal at the pixel. Then, project the pixel of the boundary onto the line segment with the highest score.

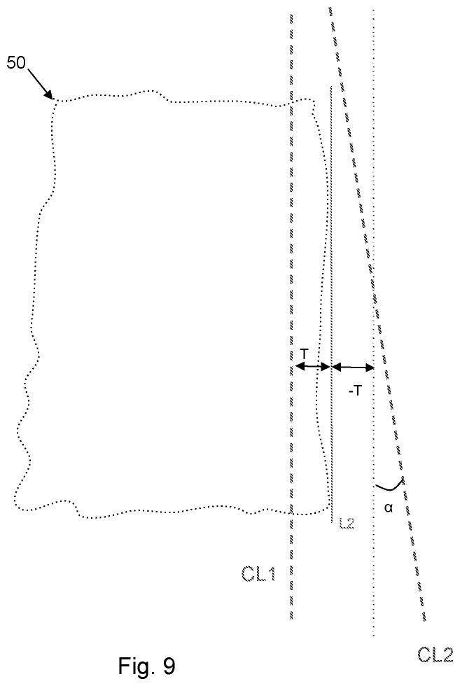

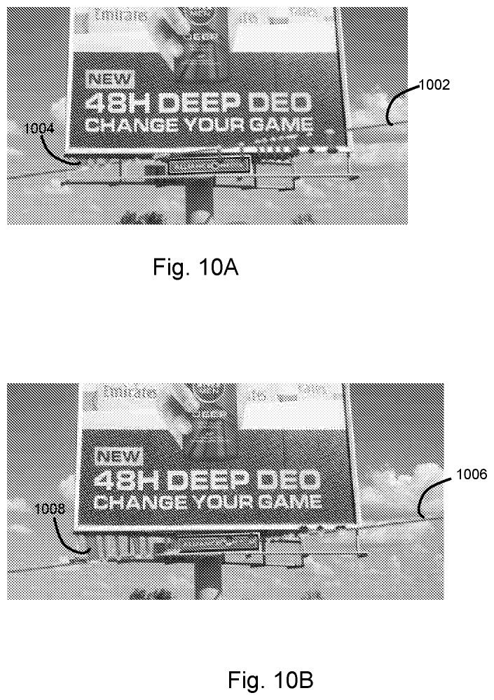

Subsequently, at step 42, the boundary lines may be rotated and translated by small increments to determine whether such transformations better conform to the edge of the embedding region mask. The process is indicated graphically in FIG. 9. For each one of the segments selected to bound the embedding region (i.e., L1, L2, L3, and L4), rotated and translated lines around the segment are considered. That is, each segment is translated by incremental values T, and rotated by incremental angles.

For example, as shown in FIG. 9, line CL1 is generated by translating L2 by T. Line CL2 is generated by translating line L2 by −T and rotating it by angle α. For each generated, transformed line, a sum of scores of each pixel p on the original embedding region boundary is calculated as:

<normal(p), normal(l)>*distance(p,l)+α *θ+β*t where normal(p) is the normal of the boundary at pixel p; normal(l) is the normal of the line l; θ and t are the rotation and translation of the transformed line with respect to the boundary edge. The line with the lowest sum value for each boundary edge is selected as the representative edge.

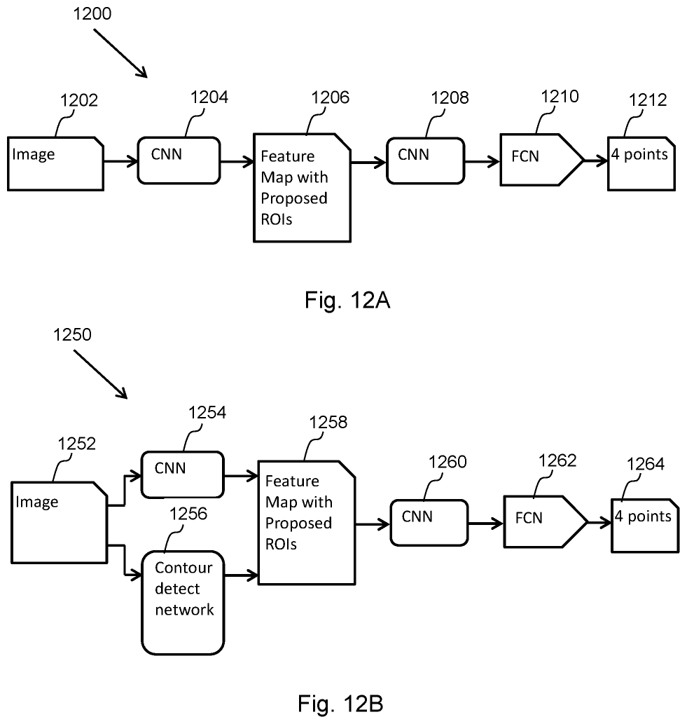

A third method of boundary refinement, indicated as step 50, includes identifying the best line segments for a refined boundary by a trained CNN. This method is described in further detail hereinbelow with respect to FIG. 12.

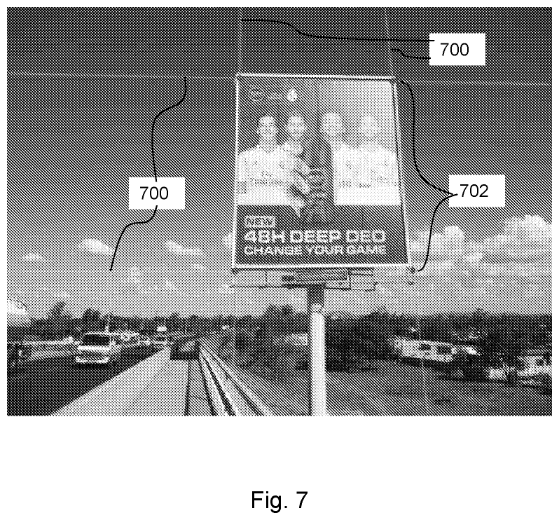

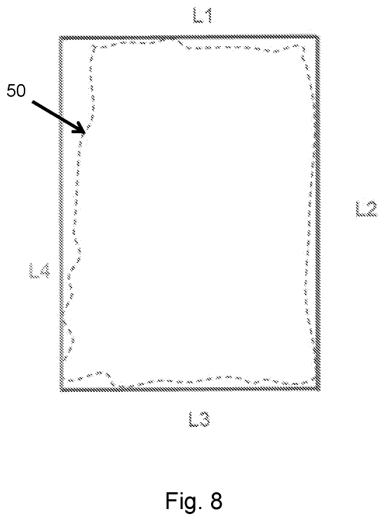

Returning to process 20 of FIG. 1, at step 60, the four-line segments with the lowest values for the equation (1), or highest score for the alternative scoring describe above, are mapped onto the image, as indicated by boundary lines 700 in FIG. 7. The four lines, denoted as L1, L2, L3, and L4 are also indicated in FIG. 8, along with the original embedding region mask edge 50.

After determining the boundary lines based on the four best line segments, corners 702 of the boundary are also determined. That is, after four edges are calculated, thereby determining a refined boundary of a refined (or “optimized”) embedding region (a quadrilateral), the corners defining the region are also calculated.

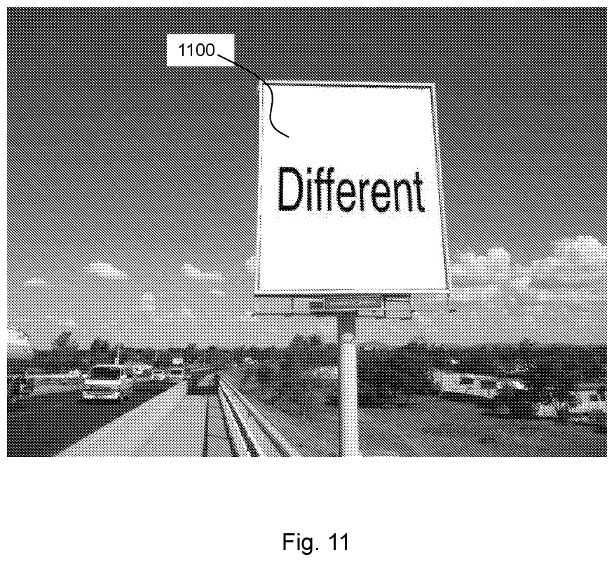

At step 62, an image that is to replace the embedding region may be transformed to the dimensions of the refined embedding region boundary and inserted in place of the embedding region in the original video frame. The replacement is indicated as replacement 1100 in FIG. 11. Subsequently, the refined embedding region may be tracked in multiple video frames, and changes in the shape of the refined embedding region may require additional transformations of the replacement image. To improve the realism of the replacement, background image properties may also be applied to the replacement image. For example, the blur level and lighting of the background may be measured and applied to the newly added image to make the embedding image appear more realistic. The system also learns the properties of the background in terms of frequency components, focus/sharpness and transforms the replacement image to be implanted to comply with these background properties. The result should be like the replaced ad would have been implanted during the originally editing of the video stream.

FIGS. 12A and 12B are flow diagrams, depicting alternative processes of determining an embedding region in an image, for replacement by a replacement image, based on Machine Learning (ML), in accordance with an embodiment of the present invention. As with process 20, described above with respect to FIG. 1, the goal is to determine four points that are the corners or the four-line segments of an embedding region.

FIG. 12A depicts a process 1200, whereby an image 1202 is processed first by a CNN 1204. However, CNN model 1204 is trained (machine learning) to output a feature map 1206 that indicates “regions of interest,” meaning regions that have traits of embedding regions. A subsequent CNN 1208 is connected to a fully convolutional network (the decoder part) or fully connected network (FCN) 1210 to process the feature map and to generate output 1212, this output being the coordinates of the four corners or the four-line segments of the refined embedding region.

FIG. 12B depicts a process 1250, whereby an image 1252 is processed in parallel by a CNN 1254 and by a contour detect network 1256, the results of the two networks being concatenated together to provide features of a feature map 1258. Following generation of the feature map, the process 1250 proceeds, like process 1200, with a subsequent CNN 1260 that is connected to a fully convolutional network (the decoder part) or fully connected network (FCN) 1262 to process the feature map and to generate output 1264, this output being the coordinates of the four corners.

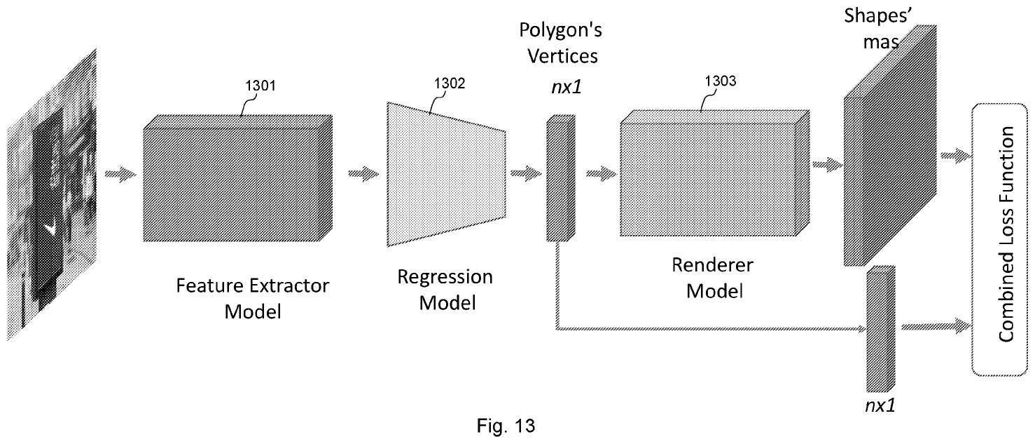

As in process 1200, the feature map 1258 indicates “regions of interest,” meaning regions that have traits of embedding regions. The shape of the output feature map is W×H×D, where W and H are the width and height of the input image and D is the depth of the feature map. Feature extraction is done by a Feature Extractor Model 1301 (shown in FIG. 13 below).

In another embodiment, the training accuracy may be further increased by generating an improved machine learning model (called Points To Polygons Net—PTPNet), which applies advanced geometrical loss functions to optimize the prediction of the vertices of a polygon. The PTPNet outputs a polygon and its mask representation.

The PTPNet architecture is shown in FIG. 13. PTPNet consists of two subnets: a Regressor model 1302 that predicts a polygon representation of the shape and a Renderer model 1303 that generates a binary mask that corresponds to the Regressor's predicted polygon.

In this example, the Regressor model outputs a vector of 2n scalars that represent the n vertices of the predicted polygon representation. However, the method provided by the present invention can be implemented to polygons of any degree.

The Renderer model generates a binary mask that corresponds to the Regressor's predicted polygon. It may be trained separately from the regression model using the polygons' contours.

The PTPNet uses a rendering component, which generates a binary mask that resemble the quadrilateral corresponding to the predicted vertices. The PTPNet loss function (which represents the difference between a predicted polygon P which is, in this example, a quadrangle and an ground truth polygon F, on the vertices and shape levels) is more accurate since it considers the difference between the predicted polygon and the ground truth polygon. This difference is considered as an error (represented by the loss function), which is used for updating the model, to reduce the error.

This way, the loss function is improved to consider not only the predicted vertices (four, in this example), but also a mapping of the predicted frame that is also compared with the ground truth (actual) polygon.

It should be noted that an image (or a frame) may contain multiple advertisements, which will be detected. In addition, the method provided by the present invention may is not limited to advertisements—it may implemented similarly to replace a place holder.

Processing elements of the system described herein may be implemented in digital electronic circuitry, or in computer hardware, firmware, software, or in combinations thereof. Such elements can be implemented as a computer program product, tangibly embodied in an information carrier, such as a non-transient, machine-readable storage device, for execution by, or to control the operation of, data processing apparatus, such as a programmable processor, computer, or deployed to be executed on multiple computers at one site or one or more across multiple sites. Memory storage for software and data may include multiple one or more memory units, including one or more types of storage media. Examples of storage media include, but are not limited to, magnetic media, optical media, and integrated circuits such as read-only memory devices (ROM) and random access memory (RAM). Network interface modules may control the sending and receiving of data packets over networks. Method steps associated with the system and process can be rearranged and/or one or more such steps can be omitted to achieve the same, or similar results to those described herein.

It is to be understood that the embodiments described hereinabove are cited by way of example, and that the present invention is not limited to what has been particularly shown and described hereinabove. For example, the process described above may be calculated for each video segment and stored with the video file or transmitted over a data network. When playing the video file, it will be possible to select personalized advertisements to be embodied within the video, based on the locality of the player.

1. A method for determining an embedding region in a video stream, comprising:
a) generating a mask of an initial estimate of an embedding region in a video frame of the video stream, wherein an initial boundary is a boundary of the initial estimate of the embedding region;
b) determining a refined boundary as a region demarked by four best line segments or four corners with sub-pixel resolution;
c) transforming a replacement image to fit the dimensions of the refined boundary; and
d) inserting the transformed replacement image into the video frame, within said refined boundary.

2. The method of claim 1, further comprising:
a) before inserting the transformed replacement image into the video frame, analyzing the properties of the background image of said video frame, in the vicinity of the replacement image; and
b) making adaptations in said transformed replacement image to comply with said background properties.

3. The method of claim 2, wherein the properties of the background includes one or more of the following:
frequency components;
focus/sharpness;
blur/noise level;
geometric transformations;
illumination.

4. The method of claim 1, wherein determining the refined boundary further comprises:
a) identifying multiple line segments in the video frame;
b) calculating line segment scores according to distances between pixels of each of the multiple line segments and the initial embedding boundary and according to gradient values at the pixels of each of the multiple line segments; and
c) determining from the line segment scores four best line segments as line segments with best line segment scores with respect to four sides of the initial boundary.

5. The method of claim 4, wherein determining the line segment scores includes calculating for each line segment the value of Σ_{∀p∈l}∇I(p)l(p)f(p)/d(p)+1), where d(p) is an average distance from the boundary of the initial estimate of the, l(p) is the pixel of the line segment, and ∇I(p) is a gradient of the line segment at a pixel p.

6. The method of claim 4, further comprising calculating the line segment scores by generating a distance map of distances between each pixel of the video frame and the initial boundary, and mapping each line segment to the distance map.

7. The method of claim 4, further comprising calculating the line segment scores as average distances of multiple pixels of the line segments from the initial boundary.

8. The method of claim 1, further comprising refining a position and orientation of the four best line segments by calculating normal distances between pixels of the best line segments and pixels of the initial boundary.

9. The method of claim 1, wherein determining the refined boundary further comprises applying a machine learning model trained to identify best line segments in an image with respect to an initial boundary.

10. The method of claim 9, further comprising:
a) mapping the vertices of predicted boundaries to a predicted polygon P and its corresponding mask representation;
b) defining a loss function representing the difference between said predicted polygon and an actual corresponding frame F; and
c) further training the machine learning model by updating the parameters of said machine learning model to reduce said difference.

11. A system for determining an embedding region in a video stream, comprising a processor and memory, wherein the memory includes instructions that when executed by the processor implement the steps of:
a) generating a mask of an initial estimate of an embedding region in a video frame of the video stream, wherein an initial boundary is a boundary of the initial estimate of the embedding region;
b) determining a refined boundary as a region demarked by four best line segments or four points with sub-pixel resolution; and
c) transforming a replacement image to fit the dimensions of the refined boundary;
and inserting the transformed replacement image into the video frame, within the refined boundary.

12. A system according to claim 11, in which the processor is further adapted to:
a) analyze the properties of the background image of the video frame, in the vicinity of the replacement image, before inserting the transformed replacement image into said video frame;
b) make adaptations in said transformed replacement image to comply with said background properties.
